(19) United States
(12) Patent Application Publication
(10) Pub. No.: US 2023/0078382 A1
(43) Pub. Date: Mar. 16, 2023

(54) MASSAGE DEVICE WITH NEGATIVE PRESSURE CAVITY

(71) Applicant: BB3000M D.O.O., Sostanj (SI)

(72) Inventor: Bostjan BUC, Mislinja (SI)

(21) Appl. No.: 17/802,230

(22) PCT Filed: Feb. 26, 2021
(86) PCT No.: PCT/EP2021/054891

§ 371 Date: Aug. 25, 2022

(30) Foreign Application Priority Data
Feb. 27, 2020 (EP) 201598430.0

(51) Int. Cl. A61H 9/00; A61H 23/00

(52) U.S. Cl. CPC A61H 9/0057; A61H 23/006

(57) ABSTRACT

A massage device includes a main body having a gripping section adapted to be held by a user, a massaging head, and an actuator configured to effect a reciprocating movement of the massaging head relative to the gripping section. The massaging head includes a negative pressure cavity connected to the suction pump.

### CROSS-REFERENCE TO RELATED APPLICATIONS

This patent application is the national phase of PCT/EP2021/054891, filed Feb. 26, 2021, which claims the benefit of European Patent Application No. 20159843.0, filed Feb. 27, 2020.

### TECHNICAL FIELD

The present invention relates to a massage device comprising a main body having a gripping section adapted to be held by a user, a massaging head, and an actuator configured to effect a reciprocating movement of the massaging head relative to the gripping section.

### BACKGROUND

Percussive massage may comprise rapid, percussive tapping, slapping and cupping of an area of the human body. A massage device for applying pressure to the body with the reciprocating motion of a massage head is known from U.S. Pat. No. 10,314,762 B1. U.S. Pat. No. 5,902,293 discloses a can body connected to a sucking pump to withdraw air from inside the can body, which is fitted with a vibrator. An apparatus to administer a skin care composition including a housing, a suction tip to engage the skin, a suction pump connected to a motor, a vibrator, and a power supply is known from US 2016/0074641 A1.

### SUMMARY

The present invention has the object of providing a user-friendly massage device and a method of operation of a massaging device.

The invention provides a hand-held massage device comprising a main body having a gripping section adapted to be held by a user, a massaging head, an actuator configured to effect a reciprocating movement of the massaging head relative to the gripping section, and a suction pump, wherein the massaging head comprises a negative pressure cavity connected to the suction pump.

Percussive massage therapy, which is applied by the reciprocating movement of the massaging head, provides strong, rapid, short-duration strokes. This action relieves muscle tension and increases blood flow to the affected area and aids in relieving pain in soft tissues. Cupping therapy generating local negative pressure on the skin increases blood circulation to the area where the cups are placed. This is known to relieve muscle tension, improve overall blood flow and promote cell repair.

According to the invention, negative pressure can be applied simultaneously together with powerful strokes of a massaging head, which aids to combine cupping and percussive massage therapy in one device. This improves the efficiency of sports-related muscle recovery and pain therapy. In a preferred embodiment, the negative pressure cavity is open towards a front end of the massaging head to apply a negative pressure on a massage recipient during the massage operation. In particular, the volume of the negative pressure cavity remains constant during the reciprocating movement of the massaging head relative to the gripping section.

The negative pressure cavity may be connected via a tube to a suction pump, wherein the suction pump is arranged on the main body. Due to the independent arrangement of the suction pump from the massage head, the massage head may be designed rather compact and robust. In particular, the suction pump could have an electrical drive or may be driven by the actuator effecting the reciprocating movement of the massaging head. The suction pump could be an electric diaphragm air pump.

In particular, the negative pressure cavity is directly connected to the suction pump via a tube. In particular, the volume of the tube remains substantially constant during the reciprocating movement of the massaging head. This arrangement facilitates a reduction of pressure variations in the negative pressure supply to the negative pressure cavity.

In particular, the gripping section is positioned below the massaging head. The gripping section may extend downwardly with respect to the massaging head. The gripping section may be arranged in the form of a pistol grip inclined to the direction of the reciprocating movement of the massaging head. The gripping section may be orthogonal to the direction of the reciprocating movement of the massaging head. This facilitates the handling of the massaging device with precision to ensure that a precise application of the massage. Further, this facilitates that the negative pressure cavity may be sealingly applied to the massage recipient's skin to enable that the negative pressure is established.

Preferably, the angle in between the extension of the gripping section and the direction of the reciprocating movement of the massaging head is in between 45 degrees and 90 degrees, more preferably in between 45 degrees and 85 degrees, more preferably in between 70 degrees and 80 degrees.

In an embodiment, the suction pump is arranged in the gripping section of the main body. The suction pump may be arranged at the opposite side of the gripping section with respect to the actuator. The vacuum pump and the actuator are of a certain weight, and their arrangement at opposite sides of the grip provides a beneficial weight distribution. In particular, this arrangement may increase the rotational inertia of the device, which compensates backlash from the reciprocating movement.

The device may comprise a battery, which is preferably arranged in the gripping section. The battery may be arranged in between the suction pump and the actuator. This further improves the weight distribution. The battery may be arranged more distant to the massaging head than the suction pump and the actuator.

The massage device may be provided with a pneumatic valve, which enables adjusting of the level of negative pressure. The pneumatic valve may be part of the suction pump or may be provided in between the suction pump and massage head.

This could be done by measuring the negative pressure level i.e. with an air pressure sensor and adjusting the negative pressure to a desired level by controlling the opening of the pneumatic valve through a feedback loop. This allows the users to set the negative pressure level individually, for example depending on the type and intensity of the sport activity or depending on the body, which will receive the massage.

Preferably, an air pressure sensor is adapted to measure the negative pressure, and the opening of the pneumatic valve is adapted to be controlled by a controller through a feedback loop based on the measured negative pressure. In one embodiment, the pneumatic valve may proportionally open and close a connection from the negative pressure system to the environment with ambient pressure. The valve may be proportionally opened by the controller to the environment with ambient pressure, to increase the pressure in the negative pressure cavity, and may be proportionally closed by the controller to the environment, to increase the pressure in the negative pressure cavity.

In another embodiment, the pneumatic valve may proportionally open and close a connection in between the suction pump and the negative pressure cavity. The valve may be proportionally closed by the controller to increase the pressure in the negative pressure cavity, and may be proportionally opened by the controller to the environment, to increase the pressure in the negative pressure cavity. Increasing the pressure means altering the pressure in the negative pressure cavity such that it is closer to ambient pressure, while lowering the pressure means altering the pressure in the negative pressure cavity such that it is closer to a vacuum.

The air pressure sensor may be arranged in the negative pressure cavity or at the suction pump, or may be connected to the tube.

A release switch may be provided, which is adapted to be actuated by a user to open or close the pneumatic valve such that the negative pressure in the negative pressure cavity is quickly equalized to ambient pressure. This enables to end the negative pressure application immediately, such that the massage device may be removed from the massage recipient easily. The release switch may be arranged in the gripping section. By activating the release switch, a valve provided at the discharge port of the suction pump may be opened.

According to an embodiment of the invention, the massaging head comprises an insert and a base body, wherein the insert is removably arranged in the base body. By applying different inserts in the base body, different massaging options are offered to a user in a single device. A user can choose different inserts depending on the massage as desired.

In particular, the insert protrudes out of the base body in the direction of the reciprocating movement. In particular, this arrangement enables that only the insert comes into contact with the massage recipient. Preferably, the insert forms a part of the negative pressure cavity. In particular, the negative pressure cavity is formed in both the base body and the insert. The portion of the negative pressure cavity distant to the massage recipient may be formed by a cavity in the base body, while the portion of the negative pressure cavity proximal to the massage recipient may be formed by the insert. In particular, the tube is connected to the portion of the negative pressure cavity distant to the massage recipient. The portion of the negative pressure cavity proximal to the massage recipient may be adapted to different requirements by exchanging inserts with different proximal negative pressure cavity geometries.

The shape of the insert protruding from the base body may be generally ball-shaped, flat, fork-shaped, or cone-shaped. Purely percussive massaging inserts without negative pressure cavity could be used if the user prefers to apply only percussive massage. According to the invention, cupping massage inserts with a negative pressure cavity may be provided. The cupping massage inserts may be U-shaped in their cross-section or have a cone-shaped opening. The cupping massage inserts may be used for a cupping massage application when activating the suction pump only. When activating the suction pump and the actuator, a combined cupping and percussive massage application is provided.

Moreover, the insert or the negative pressure cavity receiving the insert in the base body may be provided with a connector, which facilitates replacements of other inserts and retains them in the base body during the massage.

In particular, inserts can be made from a variety of materials, such as i.e. polymer, metal, glass, and composite, and may possess different hardness values.

The insert may comprise a contact element for contacting the massage recipient, wherein the contact element is made of a softer material than the remaining insert. In particular, the contact element forms an insert edge portion, which is adapted to come into contact with the massage recipient. The contact element may be made of silicone. The contact element is in particular provided along the opening in the insert towards the negative pressure cavity. This softer and thus deformable contact element allows better sealing the negative pressure cavity when in contact with the massage recipient. The soft edge portion may also improve the comfort for the massage recipient.

Preferably, the insert is at least partially arranged in the negative pressure cavity. In particular, the negative pressure cavity may be partially void despite the inserted insert. This may reduce the size, weight and production cost of the inserts, and provide an extra volume for the negative pressure, lowering pressure amplitudes. Further, the insert may protrude over the negative pressure cavity in the direction of reciprocating movement.

In one embodiment of the invention, the insert forms a part of the negative pressure cavity. Thus, the insert defines the form of the negative pressure cavity by providing the outer walls of the negative pressure cavity. Hence, it is possible to provide different shapes of negative pressure cavities by replacing the inserts in the base body of the massaging head.

Preferably, a sealing is provided in between the insert and the base body of the massage head. This may improve the fastening of the inserts in the base body of the massaging head, in particular by increasing friction forces in between the insert and the base body. Also, the sealing may reduce or avoid air leakage.

The insert may be held by a connector, such as a mechanical coupling, in the base body of the massage head.

In one embodiment, the negative pressure in the negative pressure cavity is adapted to hold the insert in the base body. This may eliminate the necessity of the usage of a connector for fastening the inserts in the base body of the massaging head.

In an embodiment, the actuator is arranged at least partially in the gripping section. This saves space and provides a compact massage device, which is easy to handle by the users.

In an alternative embodiment, the actuator is arranged above the gripping section.

According to an embodiment of the invention, the actuator comprises a crank drive having a drive shaft, which is eccentrically fixed in a crank body, wherein the crank body provides a bearing for a piston rod. Preferably, the diameter of the bearing is bigger than twice the radius of the eccentricity of the fixation of the drive shaft in the crank body. Based on lever rule, a small eccentricity allows gaining more percussive force from drive shaft of the motor; consequently a more efficient use of motor power. The relatively large bearing compared to the eccentricity may have a high mechanical durability. Furthermore, the inventive bearing design may reduce friction, and, thus, the device may be operated at higher speed and/or with a stronger massaging force.

According to a preferred embodiment of the invention, at least a rear end of the massaging head is formed as a piston guided in a bushing, wherein the actuator is connected via a pin in a hollow section in the rear end of the piston. This allows a size reduction of the moving components of the massage device and a compact design thereof. Moreover, the forces acting on the massaging head may be evenly distributed to the main body.

Preferably, the massage device comprises an acceleration sensor or pressure sensor or both configured to detect the acceleration of or pressure applied by the massaging head. Optionally, the massage device may further comprise a display indicating the pressure applied by the massaging head derived from the pressure sensor or the acceleration sensor. Accordingly, the user can control and adjust the desired pressure level. The display may be adapted to display the orientation of the massage device derived from the measured acceleration. In particular, the indicated orientation is the relative orientation in between massage device and the contact surface on a body part of the massage recipient. The orientation may be considered as beneficial, if it maximizes the contact surface between the massage head and body part. The beneficial orientation may be indicated on the display. Thus, the user may be guided to optimize the position of the device in a way to make the best use of the massage device. Preferably, the sensors are arranged at or in the massaging insert.

The massage head may have a weight of 20 g to 100 g, preferably 40 g to 60 g.

The invention further provides a massaging insert forming a part of a negative pressure cavity. In particular, the negative pressure cavity is open towards the front of the massaging insert and comprises an open connection towards its rear end, such that the negative pressure provided in the base body of the massaging head is connected to the negative pressure cavity, when the massaging insert is connected to the base body.

The invention further provides a massage device comprising a main body having a gripping section adapted to be held by a user, a massaging head, and an actuator configured to effect a reciprocating movement of the massaging head relative to the gripping section, wherein the actuator comprises a crank drive having a drive shaft, which is eccentrically fixed in a crank body, wherein the crank body provides a bearing for a piston rod, wherein the diameter of the bearing is bigger than twice the radius of the eccentricity of the fixation of the drive shaft in the crank body. The massage device may further comprise any one of the features specified above. The actuator may be arranged at least partially in the gripping section.

The invention further provides a method of operation of a massage device, in particular for a non-therapeutic massage application, comprising moving the massaging head reciprocatingly relative to a gripping section and providing a negative pressure within a cavity in the massaging head. The massage device may have the features specified above.

The invention further provides a use of negative pressure in a massaging head of a massage device in a percussive, in particular non-therapeutic massage application. In particular, the negative pressure is provided by a suction pump.

### BRIEF DESCRIPTION OF THE DRAWINGS

The invention will now be further explained with reference to an exemplary embodiment as shown in the figures.

FIG. 1 shows a side view of a massage device according to an embodiment of the invention.

FIG. 2 shows a sectional side view of a massaging head with an insert according to an embodiment of the invention.

FIG. 3 shows a sectional side view of a massaging head with an insert according to a further embodiment of the invention.

FIG. 4 shows a sectional side view of a massaging head with an insert according to a further embodiment of the invention.

FIG. 5 shows a sectional side view of an actuator according to the invention.

FIG. 6 shows a top view of the actuator according to FIG. 5.

FIG. 7 shows a side view of a massage device according to a further embodiment of the invention.

### DETAILED DESCRIPTION

FIG. 1 shows a massage device 1 according to an embodiment of the invention. The massage device 1 is a portable electromechanical device that may be used for percussive therapeutic massage application, including the operation modes: rapid strokes, suction, and a combination of rapid strokes and suction.

The massage device 1 comprises a main body 2 with a platform 200 on which a bushing 17 for a massaging head 4 with a negative pressure cavity 6 having a body engaging opening 23 and a suction pump 7 are arranged. The bushing 17 of the massaging head 4 is arranged and fastened on the platform 200 via screws. The suction pump 7 is mounted stationary on the platform 200. The suction pump 7 might be provided with a pneumatic valve 27. The massaging head 4 is connected to the suction pump 7 via a tube 8 on a suction opening 60 of the massaging head 4.

The massage device 1 may comprise a negative pressure release switch 29 which may be actuated by a user to open the pneumatic valve, such that the negative pressure in the negative pressure cavity 6 is quickly equalized to ambient pressure.

The main body 2 has a gripping section 3 for a user to hold the massage device 1. The gripping section 3 is positioned below the platform 200. An actuator 5 configured to effect a reciprocating movement of the massaging head 4 relative to the gripping section 3 is partially arranged in the gripping section 3 and extends above the platform 200. It is also possible that the actuator 5 is arranged on the main body 2 above the platform 200. The length 26 of the reciprocating part of the massaging head 4 may be in between 50 mm to 200 mm, preferably around 100 mm.

Through the reciprocating movement of the massaging head 4 extending from a retracted first position to a protruding second position, the massaging head 4 can apply rapid strokes on the chosen body region of the massage recipient in varying speeds defining stroke levels. After engaging the body engaging opening 23 of the massaging head 4 on the body of the massage recipient, through the operation of the suction pump 7, the air within the negative pressure cavity 6 of the massaging head 4 is partly evacuated to produce suction on the body surface of the massage recipient. Thus, the rapid stroke and suction modes can be operated simultaneously.

The massage device 1 may comprise an acceleration sensor 19, air pressure sensor 20 and a mechanical pressure sensor 21, which can be positioned in the vicinity of the actuator 5 or the massaging head 4. An air pressure sensor 20 may be provided within the negative pressure cavity 6 of the massaging head 4 to detect the air pressure within the cavity 6. Using the acceleration sensor 19, the velocity and position of the massaging head 4 may be estimated. The mechanical pressure sensor 21 may be positioned in between the actuator 5 and the gripping section 3, such that the force applied by the actuator 5 may be determined and the pressure applied to the massage recipient can be estimated. An air pressure sensor 20 may be provided in the massaging head, in particular in between the base body 10 and an insert 9 of the base body 10.

The massage device 1 can comprise a user interface 22, for instance a touchscreen, which can be arranged on the gripping section 3 or on an enclosure (not shown) covering the part of the main body above the platform 200. By means of the user interface 22, the user can chose different massage treatment options such as rapid stroke, suction or simultaneous rapid stroke and suction massage. The user may also choose different massage options regarding the pressure level depending on the activity performed by the massage receiver before the massage such as running, cycling, yoga etc. The massaging options offered to the user could also depend on the health and wellness of the user, for example if the massage receiver has an injury or not. The massaging options could be chosen also depending on the level of muscle soreness and how hard or soft the muscle feels. The user may also choose massaging options with different negative pressure levels and stroke levels. The user interface 22 may also be provided on a remote device (e.g. smartphone) including an adapted application software. By choosing the desired massage treatment option on the user interface 22, negative pressure levels and stroke levels, with the engagement of the body engaging opening 23 of the massaging head 4 on the body of the massage recipient, the massaging device 1 will automatically adjust the negative pressure and stroke levels according to the chosen parameters.

The negative pressure diminishes automatically, when the body engaging opening 23 of the massaging head 4 disengages from the present body spot and engages on the same or another body spot of the massage recipient.

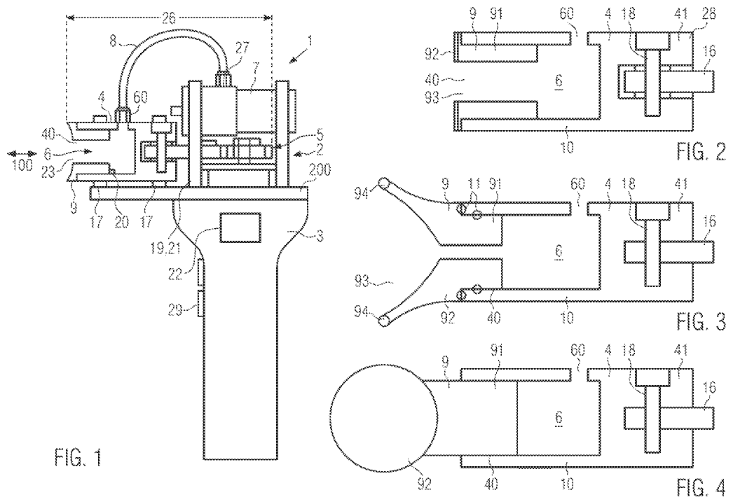

FIG. 2 shows a sectional side view of the massaging head 4 with an insert 9. The massaging head 4 comprises an insert 9 and a base body 10, wherein the insert 9 is removably arranged on the front end 40 of the massaging head 4 in the base body 10. The rear end 41 of the massaging head 4 is formed as a piston 28. A piston rod 16 of the actuator 5 is connected by means of a pin 18 placed in the massaging head 4.

Inserts 9 may have different sizes, forms, material properties and functions. For instance, an insert 9 may comprise a connector, which may lock the insert 9 by form or friction fit in the base body 10. Thus, the inserts 9 can be installed without any tool or screwing step. A rear insert portion 91 of the insert 9 is fully inserted in the base body 10. The rear insert portion 91 is preferably a cylindrical body and made of a flexible polymer. A front insert portion 92 of the insert 9 is protruding out of the base body 10 in the direction 100 of the reciprocating movement. The front insert portion 92 may comprise a circular opening 93.

FIG. 3 shows a sectional side view of the massaging head 4 with an insert 9 having a front insert portion 92 with a cone-shaped opening 93. The rear insert portion 91 of the insert 9 is fully inserted in the base body 10. A contact element 94 in the form of a silicone ring is provided around the opening 93.

A sealing 11 may be provided in between the base body 10 of the massaging head 4 and the insert 9. The diameter of the opening 93, the length and angulation of the cone of the insert 9 lying outside of the massaging head 4 can vary.

FIG. 4 shows a sectional side view of the massaging head 4 with an insert 9 having a tip with no opening. This insert 9 is merely held by the negative pressure in the negative pressure cavity 6, but does not provide any cupping function. The front insert portion 92 of the insert 9 protruding out of the base body 10 may comprise a ball-shaped or flat-shaped or fork-shaped tip.

The length of the rear insert portions 91 extending within the base body 10 of the massaging head 4 may vary as well. This length can be almost equal to the length of the negative pressure cavity 6 or smaller than the length of the negative pressure cavity 6. For the former case, the inserts 9 may have a suction opening (not shown) in their rear insert portions 91 corresponding to the same spot of the suction opening 60 of the massaging head 4.

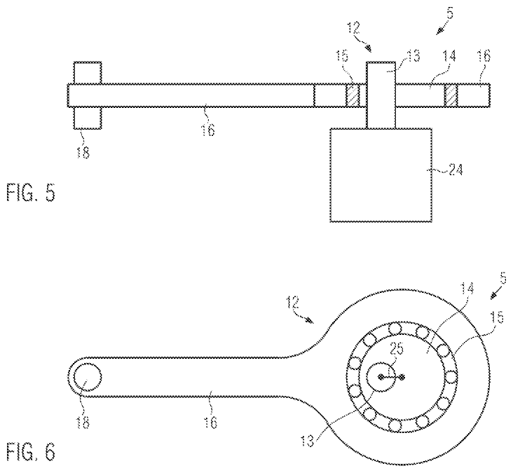

FIG. 5 illustrates a sectional side view of an actuator 5, which is partially shown in FIG. 1. The actuator is configured to effect a reciprocating movement of the massaging head 4. The actuator 5 comprises a crank drive 12, having a drive shaft 13 connected to a motor 24, preferably a brushless DC motor. The drive shaft 13 is eccentrically fixed in a crank body 14. The crank body 14 provides a bearing 15 for a piston rod 16. The piston rod 16 is mechanically connected to the massaging head 4 with the pin 18 as shown in FIGS. 2, 3, and 4.

FIG. 6 illustrates a top view of the actuator 5. The eccentricity 25 defined as the distance between the center of the crank body 14 and the drive shaft 13 may be in between 3 mm to 9 mm, preferably around 6 mm.

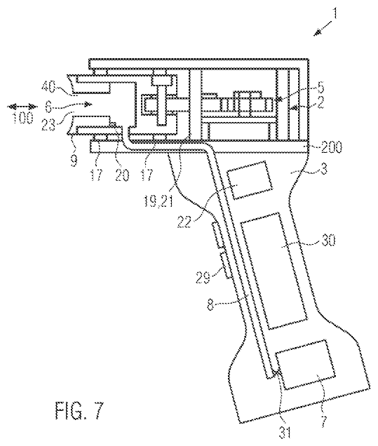

FIG. 7 shows a further embodiment of the massage device 1. The suction pump 7 is arranged in the gripping section 3 at the opposite side of the gripping section 3 with respect to the actuator 5. A battery 30 is arranged in the gripping section 3 and electrically connected to both the actuator 5 and the suction pump 7. The tube 8 directly connects the suction pump 7 and the negative pressure cavity 6. A pneumatic valve 31 is provided as part of the suction pump 7. A controller may receive a feedback signal from the air pressure sensor 20 and control the pneumatic valve 31 in a feedback loop. In particular, the controller may open or close the valve depending on the difference in between a set target pressure and the measured pressure from the air pressure sensor. The controller may be a PID-controller or an on/off-controller.

Actuation of the release switch may open the pneumatic valve 31 towards the environment, such that the pressure in the negative pressure cavity is equalized to ambient pressure. The gripping section 3 extends in an angle of roughly 85 degrees regarding the direction 100 of the reciprocating movement of the massaging head 4.

The massage device 1 may comprise an air quality sensor (not shown). With the air quality sensor user can measure exactly the air quality of the room or area, where the user treats himself with the massage device 1. This could be shown to the user through the user interface 22 so that the user can change location or ventilate the room in order to obtain the best possible relaxing experience.

The massage device 1 may be linked to a remote device, particularly to an adapted application software (app) such as health or fitness apps via a communication interface in the massage device. The user may be notified with a suitable massage operation option depending on the type and duration of the sport type registered in the fitness app. The user may input information through the user interface 22, for example the touchscreen of the massage device 1 or an app in a remote device, after the massage operation, regarding the parameters of the operation or type of sport activity or health problem or level and type of pain remained on a specific muscle group after the current massage operation. Depending on this information, the user can receive a feedback with a recommendation for a further massage treatment. This input data for each user may be stored in the massage device 1 or in the app on the remote device. A specific recovery program may be displayed and selectable on the user interface 22. Training videos for using the massage device 1 may be displayed on the user interface 22.

1. A massage device (1) comprising:
a main body (2) having a gripping section (3) adapted to be held by a user;
a massaging head (4);
an actuator (5) configured to effect a reciprocating movement of the massaging head (4) relative to the gripping section (3); and
a suction pump (7);
wherein the massaging head (4) comprises a negative pressure cavity (6) connected to the suction pump (7);
wherein the massaging head (4) comprises an insert (9) and a base body (10), wherein the insert (9) is removably arranged in the base body (10), wherein the insert (9) protrudes out of the base body (10) in a direction (100) of the reciprocating movement and the insert (9) forms a part of the negative pressure cavity (6).

2. The massage device according to claim 1, wherein the negative pressure cavity (6) is open towards a front end (40) of the massaging head (4) to apply a negative pressure on a massage recipient during a massage operation.

3. The massage device according to claim 1, wherein the negative pressure cavity (6) is directly connected via a tube (8) to the suction pump (7).

4. The massage device according to claim 1, wherein the gripping section (3) is positioned below the massaging head (4).

5. The massage device according to claim 1, wherein an angle between an extension of the gripping section (3) and the direction (100) of the reciprocating movement of the massaging head (4) is between 45 degrees and 90 degrees.

6. The massage device according to claim 1, wherein the suction pump (7) is arranged in the gripping section (3) at an opposite side of the gripping section (3) with respect to the actuator (5).

7. The massage device according to claim 1, wherein a battery (30) is arranged in the gripping section (3).

8. The massage device according to claim 1, comprising a pneumatic valve (31), adapted to adjust a level of negative pressure, wherein the pneumatic valve (31) is either part of the suction pump (7) or provided between the suction pump (7) and massaging head (4).

9. The massage device according to claim 8, wherein an air pressure sensor (20) is adapted to measure the negative pressure, and an opening of the pneumatic valve (31) is adapted to be controlled through a feedback loop.

10. The massage device according to claim 8, further comprising a release switch (29) adapted to actuate the pneumatic valve (31) such that the negative pressure in the negative pressure cavity (6) is equalized to ambient pressure.

11. The massage device according to claim 1, wherein the insert (9) is at least partially arranged in the negative pressure cavity (6).

12. The massage device according to claim 1, wherein a sealing (11) is provided in between the insert (9) and the base body (10) of the massaging head (4).

13. The massage device according to claim 1, wherein negative pressure (6) in the negative pressure cavity (6) is adapted to hold the insert (9) in the base body (10).

14. The massage device according claim 1, wherein the insert (9) comprises a contact element (94) for contacting a massage recipient, wherein the contact element (94) is made of a softer material than a remainder of the insert (9).

15. The massage device according claim 1, wherein the actuator (5) is arranged at least partially in the gripping section (3).

16. The massage device according to claim 1, wherein the actuator (5) comprises a crank drive (12), having a drive shaft (13), which is eccentrically fixed in a crank body (14), wherein the crank body (14) provides a bearing (15) for a piston rod (16), wherein a diameter of the bearing (15) is bigger than twice a radius of an eccentricity (25) of the fixation of the drive shaft in the crank body (14).

17. The massage device according to claim 1, wherein at least a rear end (41) of the massaging head (4) is formed as a piston (28) guided in a bushing (17), wherein the actuator (5) is connected via a pin (18) in a hollow section in the rear end of the massaging head (41).

18. The massage device according to claim 1, wherein the massaging device (1) comprises one of an acceleration sensor (19) and a pressure sensor (21) configured to detect an acceleration of or pressure applied by the massaging head (4), respectively.

19. The massage device according to claim 1, wherein the massaging device (1) further comprises a display (21) configured to indicate an orientation of the massage device (1) depending on a detected acceleration of or pressure applied by the massaging head (4).

20. A massaging insert (9) for the massaging device (1) according to claim 1, wherein the massaging insert forms a part of the negative pressure cavity (6), wherein the negative pressure cavity (6) is open towards a front of the massaging insert (9) and comprises an open connection towards its rear end, such that a negative pressure provided in the base body (10) of the massaging head (4) is connected to the negative pressure cavity (6), when the massaging insert (9) is connected to the base body (10).

21-26. (canceled)
